(19) United States
(12) Patent Application Publication
(10) Pub. No.: US 2013/0200539 A1
(43) Pub. Date: Aug. 8, 2013

(54) APPARATUS AND METHOD OF MANUFACTURING LIGHT GUIDE PLATE HAVING REDUCED THICKNESS

(71) Applicant: CHIA-LING HSU, Tu-Cheng (TW)

(72) Inventor: CHIA-LING HSU, Tu-Cheng (TW)

(73) Assignee: HON HAI PRECISION INDUSTRY CO., LTD., Tu-Cheng (TW)

(21) Appl. No.: 13/549,544

(22) Filed: Jul. 16, 2012

(30) Foreign Application Priority Data
Feb. 8, 2012 (TW) 101104022

(51) Int. Cl. B29D 11/00; B29C 33/06

(52) U.S. Cl. 264/1.27; 425/174.4

(57) ABSTRACT

An apparatus for manufacturing light guide plate includes a coater, a first pressing roller, a second pressing roller, and two UV lamps. The first pressing roller and the second pressing roller are positioned nearby each other and space a predetermined distance from each other. The coater distributes UV curable glue through a molding channel between the first pressing roller and the second pressing roller. The first pressing roller and the second pressing roller cooperatively press the distributed UV curable glue. Each of the first and the second pressing roller includes a hollow transparent main body and a molding core sleeving the main body. The molding core is made of resin containing fluorine. The two UV lamps are respectively received in the two main bodies and emit UV light to solidify the UV curable glue pressed between the first and the second pressing roller.

### BACKGROUND

1. Technical Field

The present disclosure relates to an apparatus for manufacturing light guide plates and a method for manufacturing light guide plates using the apparatus.

2. Description of Related Art

A light guide plate is typically employed in a backlight module for converting a point light source or a linear light source into an area/plane light source. The light guide plate includes a number of microstructures. The microstructures may be formed on a surface or two opposite surfaces of the light guide plate. The light guide plate with the microstructures can be manufactured through an injection molding method or a printing method.

However, the above mentioned printing method must employ a PET film as a substrate and thus this increases a total thickness of the manufactured light guide plate. In addition, a ratio of light transmission of the PET film is about 90%, which will also limit a total ratio of light transmission of the manufactured light guide plate. Furthermore, the UV curable needs to adhere the PET film firmly and needs to easily depart from the pressing roll at the same time, therefore, it is difficult to prepare the UV curable glue with a suitable viscosity coefficient.

Therefore, it is desirable to provide an apparatus and method for manufacturing a light guide plate that can overcome the above-mentioned limitations.

### BRIEF DESCRIPTION OF THE DRAWINGS

Many aspects of the embodiments should be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view of an apparatus for manufacturing a light guide plate, according to a first embodiment of the present disclosure.

FIG. 2 is a flow chart of a method for manufacturing light guide plate, according to a second embodiment of the present disclosure.

FIG. 3 is a schematic view of an apparatus for manufacturing a light guide plate, according to a third embodiment of the present disclosure.

### DETAILED DESCRIPTION

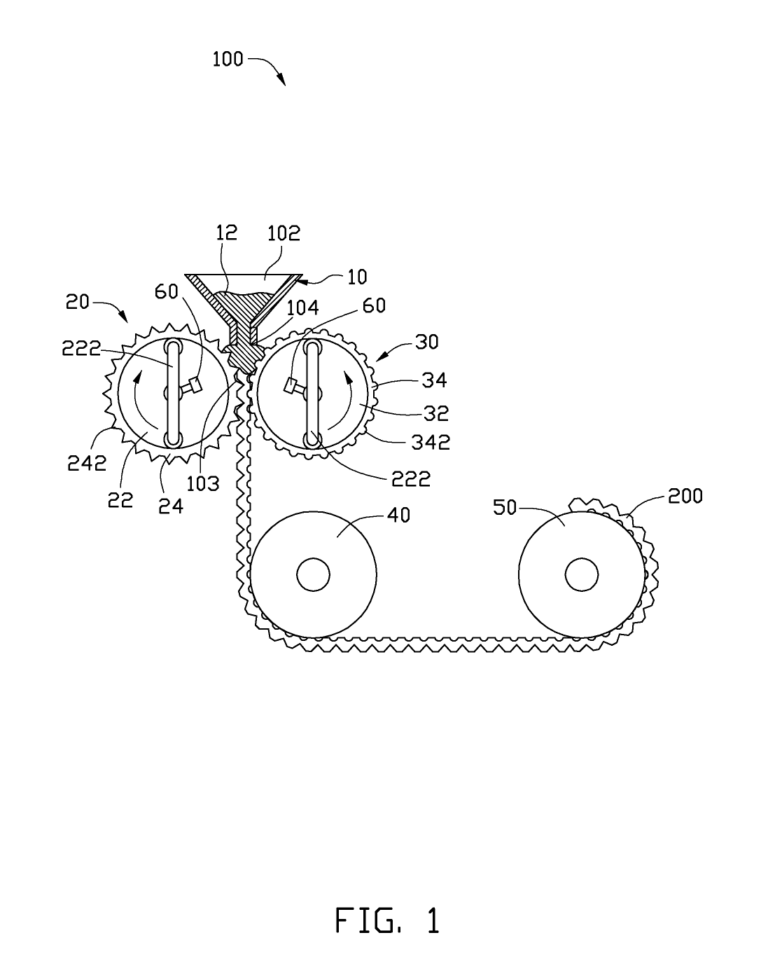

FIG. 1, is an apparatus 100, according to a first embodiment. The apparatus 100 includes a coater 10, a first pressing roller 20, a second pressing roller 30, a transmission roller 40, a winding roller 50, two supporting devices 222, and two UV lamps 60.

The coater 10 is used for containing UV curable glue 12. The coater 10 is substantially funnel-shaped and includes a mouth 102 and a pipe 104. The UV curable glue 12 flows into the coater 10 through the mouth 102 and flows out from the coater 10 through the pipe 104.

The first pressing roller 20 and the second pressing roller 30 are located nearby each other and spaced at a predetermined distance from each other. The first pressing roller 20 rotates around a first central axis, and the second pressing roller 30 rotates around a second central axis. A molding channel 103 is formed between the first pressing roller 20 and the second pressing roller 30. The UV curable glue 12 from the pipe 104 directly flows into the molding channel 103. The distance between the first pressing roller 20 and the second pressing roller 30 is substantially equal to a predetermined thickness of light guide plates 200 to be manufactured.

The first pressing roller 20 and the second pressing roller 30 cooperate to press the UV curable glue 12. The first pressing roller 20 includes a hollow cylindrical first main body 22 and a first molding core 24 sleeving and adhering the first main body 22. The first molding core 24 defines a number of first microstructures 242 on its outer surface. The second pressing roller 30 includes a hollow cylindrical second main body 32 and a second molding core 34 sleeving and adhering the second main body 32. The second molding core 34 defines a number of second microstructures 342 on its outer surface. The first main body 22 and the second main body 32 are on a same height with respect to the coater 10. The pipe 104 is aligned with the molding channel 103. The first microstructures 242 and the second microstructures 342 are printed on two opposite surfaces of the UV curable glue 12 when the UV curable glue 12 passes through the molding channel 103.

The first main body 22 and the second main body 32 are made of transparent material, such as silicon dioxide (SiO₂). The first molding core 24 and the second molding core 34 are made of resin of which the molecule chain including fluorine, such as Ethylene Tetrafluoroethylene (ETFE), or Polytetrafluoroethylene (PTFE). The first microstructures 242 and the second microstructures 342 are formed by roller pressing method.

In this embodiment, each of the first microstructures 242 is substantially V-shaped, and each of the second microstructures 342 is substantially dot-shaped. The shape of the first microstructures 242 and the second microstructures 342 are not limited to this embodiment.

The two supporting device 222 are still and are partially extended into the first main body 22 and the second main body 32 respectively. The first main body 22 and the second main body 32 are rotatably positioned on the two supporting devices 222 respectively, and the first main body 22 and the second main body 32 can rotate with respect to the corresponding supporting devices 222. A rotating direction of the first pressing roller 22 is reverse to that of the second pressing roller 32. In this embodiment, the first pressing roller 22 is rotated clockwise, and the second pressing roller 32 is rotated counterclockwise.

The two UV lamps 60 are used for solidifying the UV curable glue 12 pressed by the first pressing roller 20 and the second pressing roller 30. The two UV lamps 60 are received in the first main body 22 and the second main body 32 respectively and are fixed on the two supporting devices 222 respectively. The UV lamp 60 in the first pressing roller 20 emits UV light towards the second pressing roller 30. The UV lamp 60 in the second pressing roller 30 emits UV light towards the first pressing roller 20.

The transmission roller 40 is positioned under the second pressing roller 30 and is used for transmitting the solidified UV curable glue 12 towards the winding roller 50. The transmission roller 40 rotates around a third central axis parallel to the second central axis of the second pressing roller 30. The winding roller 50 is used for winding the solidified UV curable glue.

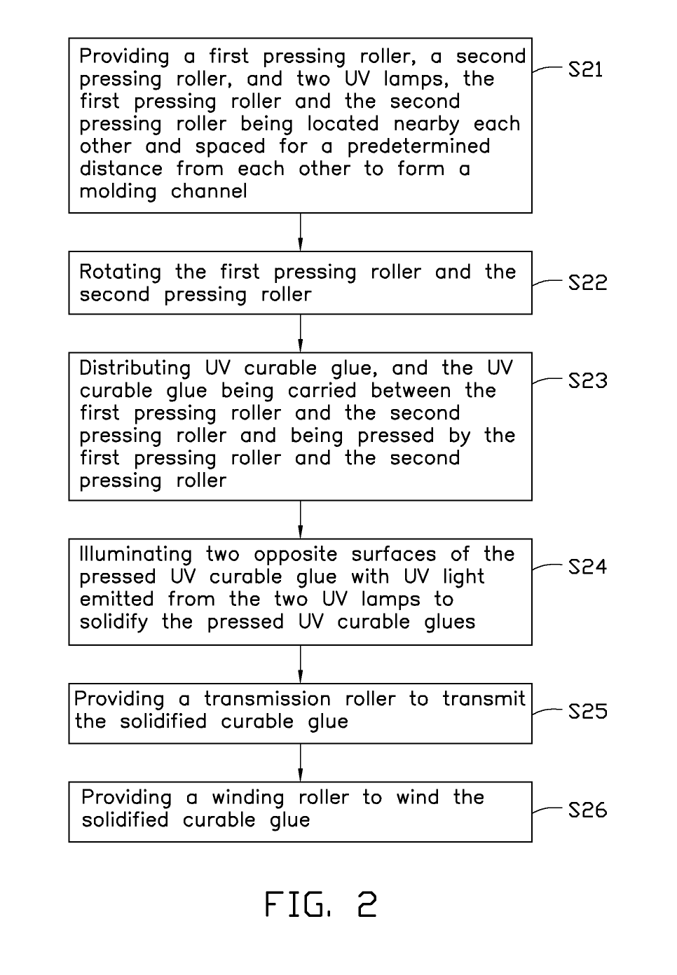

Referring to FIG. 2, a flow chart of a method for manufacturing a light guide plate according to a second embodiment. The method using the apparatus 100 includes following steps.

In step S21, a first pressing roller 20 and a second pressing roller 30 are provided, and the first pressing roller 20 and the second pressing roller 30 are located nearby each other and spaced a predetermined distance from each other. The first pressing roller 20 includes a number of first microstructures formed on the outer surface, and the second pressing roller 20 includes a number of second microstructures formed on the outer surface.

In step S22, the first pressing roller 20 and the second pressing roller 30 are rotated in reverse directions to each other. In this embodiment, the first pressing roller 20 is rotated clockwise, and the second pressing roller 30 is rotated counterclockwise.

In step S23, UV curable glue 12 in the molding channel 103 is distributed between the first pressing roller 20 and the second pressing roller 30. The UV curable glue 12 is pressed by the first pressing roller 20 and the second pressing roller 30 to print the first microstructures 242 and the second microstructures 342 on the two opposite surfaces of the UV curable glue 12 respectively.

In step S24, the two opposite surfaces of the pressed UV curable glue is illuminated by the UV light emitting from the two UV lamps, and thus the pressed UV curable glues is solidified.

In step S25, a transmission roller 40 is provided to transmit the solidified curable glue.

In step S26, a winding roller 50 is provided to wind the solidified curable glue.

The first pressing roller 20, the second pressing roller 30, and the winding roller 40 can be driven by motors (not shown).

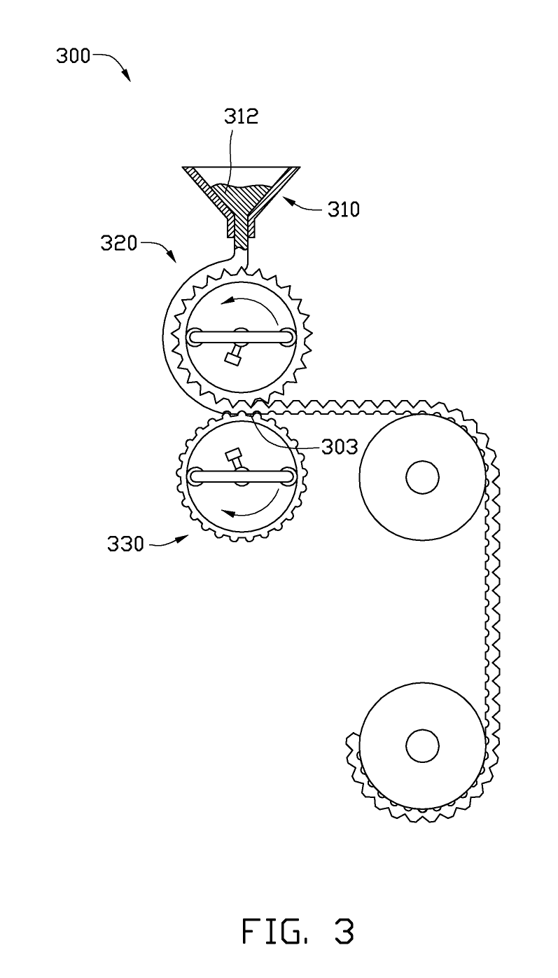

FIG. 3, is an apparatus 300 for manufacturing a light guide plate, according to a third embodiment. The apparatus 300 is slightly different from that of the first embodiment. In this embodiment, the coater 310 is a precision slot die which can control the thickness of the light guide plate 200 exactly. The first pressing roller 320 is positioned under the coater 310, and the second pressing roller 330 is positioned under the first pressing roller 320. The first pressing roller 320 and the second pressing roller 330 are arranged in a vertical straight line. In use, the UV curable glue 312 from the coater 310 is uniformly distributed on an outer surface of the first pressing roller 320. The UV curable glue 312 is adhered on the first pressing roller 320 and then enters into a molding channel 303 between the first pressing roller 320 and the second pressing roller 330 when the first pressing roller 320 rotates.

The apparatuses 100, 300 and method for manufacturing the light guide plate employ two UV lamps 60 for solidifying the UV curable glue at the same time, thus a PET film can be eliminated. Therefore, the thickness of the manufactured light guide plate can be reduced, and the ratio of light transmission of the manufactured light guide plate can be enhanced. In addition, because the UV curable glue is no need to adhere on a PET film, therefore, it is easy to prepare the UV curable glue.

It will be understood that the above particular embodiments and methods are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. An apparatus for manufacturing a light guide plate, comprising:
a coater for containing UV curable glue therein;
a first pressing roller comprising:
a hollow cylindrical first main body made of transparent material; and
a first molding core enclosing the first main body and made of resin containing fluorine;
a second pressing roller comprising:
a hollow cylindrical second main body made of transparent material; and
a second molding core enclosing the second main body and made of resin containing fluorine; and
two UV lamps;
wherein the first pressing roller and the second pressing roller are located nearby each other and spaced a predetermined distance from each other to form a molding channel therebetween, the coater is configured for distributing the UV curable glue in the molding channel, the first pressing roller and the second pressing roller are configured for cooperatively pressing the distributed UV curable glue, the two UV lamps are received in the first main body and the second main body respectively, the two UV lamp are configured for emitting UV light to solidify two opposite surfaces of the UV curable glue pressed between the first pressing roller and the second pressing roller.

2. The apparatus of claim 1, wherein the first molding core comprises a plurality of first microstructure on its outer surface for printing the first microstructures on a first surface of the UV curable glue, the second molding core comprises a plurality of second microstructure on its outer surface for printing the second microstructures on a second surface of the UV curable glue opposite to the first surface.

3. The apparatus of claim 2, wherein each of the first microstructures is substantially V-shaped.

4. The apparatus of claim 2, wherein each of the second microstructures is substantially dot-shaped.

5. The apparatus of claim 1, wherein the first main body and the second main body are made of silicon dioxide.

6. The apparatus of claim 1, wherein each of the first molding core and the second molding core is made of Ethylene Tetrafluoroethylene or Polytetrafluoroethylene.

7. The apparatus of claim 1, further comprising a winding roller, wherein the winding roller is configure for winding the solidified UV curable glue.

8. The apparatus of claim 7, further comprising a transmission roller, wherein the transmission roller is configured for guiding the solidified UV curable glue from the first pressing roller and the second pressing roller towards the winding roller.

9. The apparatus of claim 1, wherein the coater is substantially funnel-shaped and comprises a mouth and a pipe, the UV curable glue flows into the coater through the mouth and flows out the coater through the pipe.

10. The apparatus of claim 11, wherein the first main body and the second main body are on a same height with respect to the coater, a extending direction of the pipe is aligned with the molding channel.

11. The apparatus of claim 1, wherein the first pressing roller is positioned under the coater, the second pressing roller and the first pressing roller are arranged in a vertical straight line.

12. The apparatus of claim 1, further comprising two supporting devices partially extending into the first main body and the second main body respectively, and the first pressing roller and the second pressing roller are rotatably positioned on the two supporting devices respectively and are capable of rotating with respect to the two supporting devices respectively, the two UV lamps are fixed on the corresponding supporting devices.

13. A method for manufacturing light guide plate, comprising:
providing a first pressing roller, a second pressing roller, and two UV lamps, the first pressing roller and the second pressing roller being located nearby each other and spaced a predetermined distance from each other to form a molding channel, the first pressing roller comprising a hollow cylindrical first main body and a first molding core enclosing the first main body, the second pressing roller comprising a hollow cylindrical second main body and a second molding core enclosing the second main body, the first main body and the second main body being made of transparent material, the first molding core and the second molding core made of resin containing fluorine, the two UV lamps being received in the first main body and the second main body;
providing a coater containing UV curable glue;
rotating the first pressing roller and the second pressing roller, a rotating direction of the first pressing roller being reverse to a rotating direction of the second pressing roller;
distributing the UV curable glue through the molding channel, wherein the UV curable glue is pressed by the first pressing roller and the second pressing roller; and
illuminating two opposite surfaces of the pressed UV curable glue with UV light emitted from the two UV lamps to solidify the pressed UV curable glues.

14. The method of claim 13, further comprising:
winding the solidified curable glue by using a winding roller.

15. The method of claim 13, wherein the UV curable glue from the coater is directly flowing into the molding channel.

16. The method of claim 13, wherein the UV curable glue from the coater is adhered on the first pressing roller and then carried into the molding channel when the first pressing roller rotates.

17. The method of claim 13, wherein the first molding core comprises a plurality of first microstructure on its outer surface for printing the first microstructures on a surface of the UV curable glue, the second molding core comprises a plurality of second microstructure on its outer surface for printing the second microstructures on another surface of the UV curable glue.

18. The method of claim 13, wherein the first main body and the second main body are made of silicon dioxide.

19. The method of claim 13, wherein the first molding core and the second molding core are made of Ethylene Tetrafluoroethylene or Polytetrafluoroethylene.
